(19) United States
(12) Patent Application Publication
(10) Pub. No.: US 2007/0228975 A1
(43) Pub. Date: Oct. 4, 2007

(54) PLASMA DISPLAY PANEL

(75) Inventors: Wonbae PARK, Suwon-si (KR); Jongrae LIM, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/694,200

(22) Filed: Mar. 30, 2007

(30) Foreign Application Priority Data
Mar. 30, 2006 (KR) 10-2006-0029226

(51) Int. Cl. H01J 17/49

(52) U.S. Cl. 313/586; 313/582; 313/587

(57) ABSTRACT

A plasma display panel is disclosed. The plasma display panel includes a substrate, a plurality of electrodes, and a dielectric layer. The substrate includes a plurality of substrate depression portions spaced from each other with a predetermined distance therebetween. The plurality of electrodes are positioned between the substrate depression portions. The dielectric layer covers upper portions of the plurality of electrodes and an upper portion of the substrate.

This application claims the benefit of Korean Patent Application No. 10-2006-0029226 filed on Mar. 30, 2006, which is hereby incorporated by reference.

### BACKGROUND

1. Field

This document relates to a display panel, and more particularly, to a plasma display panel.

2. Description of the Related Art

The plasma display panel has the structure in which barrier ribs formed between a front panel and a rear panel forms unit discharge cell or a plurality of discharge cells. Each discharge cell is filled with an inert gas containing a main discharge gas such as neon (Ne), helium (He) or a mixture of Ne and He, and a small amount of xenon (Xe). The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

### SUMMARY

In one aspect, a plasma display panel comprises a substrate comprising a plurality of substrate depression portions spaced from each other with a predetermined distance therebetween, a plurality of electrodes positioned between the substrate depression portions, and a dielectric layer covering upper portions of the plurality of electrodes and an upper portion of the substrate.

A depth of the substrate depression portion may be equal to or less than one half of a thickness of the substrate.

A width of the substrate depression portion may range from 100 μm to 900 μm.

A width of the electrode may be less than one quarter of the width of the substrate depression portion.

A thickness of the dielectric layer formed on an upper portion of the substrate depression portion may be substantially equal to a thickness of the dielectric layer formed on the remaining portion excepting the substrate depression portion from the substrate.

A thickness of the dielectric layer may range from 5 μm to 100 μm.

The plasma display panel may further comprise a black layer positioned between a first electrode of the plurality of electrodes and a second electrode of the plurality of electrodes closest to the first electrode on the upper portion of the substrate.

In another aspect, a plasma display panel comprise a substrate comprising a plurality of electrode depression portions spaced from each other with a predetermined distance therebetween, a plurality of electrodes positioned inside the electrode depression portions, and a dielectric layer with a differential thickness positioned on an upper portion of the substrate.

The plasma display panel may further comprise a black layer positioned between a first electrode of the plurality of electrodes and a second electrode of the plurality of electrodes closest to the first electrode on the upper portion of the substrate.

A thickness of the dielectric layer positioned on an area where the plurality of electrodes and the black layer are positioned may be more than a thickness of the dielectric layer positioned on an area where the plurality of electrodes and the black layer are not positioned.

A thickness of the dielectric layer positioned on an area where the plurality of electrodes and the black layer may be positioned ranges from 5 μm to 100 μm.

A depth of the electrode depression portion may be equal to or less than one half of a thickness of the substrate.

In still another aspect, a plasma display panel comprise a substrate comprising a plurality of electrode depression portions spaced from each other with a predetermined distance therebetween and a plurality of substrate depression portions positioned between the electrode depression portions, a plurality of electrodes positioned inside the electrode depression portions, and a dielectric layer positioned on an upper portion of the substrate.

A depth of the electrode depression portion and a depth of the substrate depression portion each may be equal to or less than one half of a thickness of the substrate.

The depth of the electrode depression portion may be less than the depth of the substrate depression portion.

A width of the substrate depression portion may range from 100 μm to 900 μm.

A width of the substrate depression portion may be more than a width of the electrode depression portion.

A thickness of the dielectric layer positioned on an upper portion of the electrode depression portion may be substantially equal to a thickness of the dielectric layer positioned on an upper portion of the substrate depression portion.

The thickness of the dielectric layer may range from 5 μm to 100 μm.

The plasma display panel may further comprise a black layer positioned between a first electrode of the plurality of electrodes and a second electrode of the plurality of electrodes closest to the first electrode on the upper portion of the substrate.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display panel according to embodiments;

FIG. 2 illustrates a structure of a front panel of a plasma display panel according to a first embodiment;

FIG. 3 illustrates a structure of a front panel of a plasma display panel according to a second embodiment;

FIG. 4 illustrates a structure of a front panel of a plasma display panel according to a third embodiment; and

FIG. 5 sequentially illustrates processes for manufacturing the front panel according to the embodiments.

### DETAILED DESCRIPTION OF EMBODIMENTS

Reference will now be made in detail exemplary embodiments of which are illustrated in the accompanying drawings.

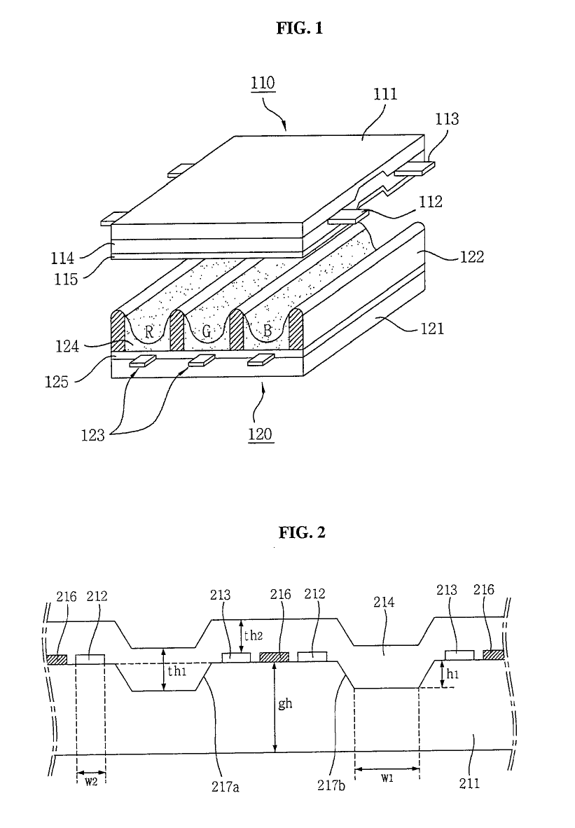

FIG. 1 illustrates a plasma display panel according to embodiments.

Referring to FIG. 1, the plasma display panel according to the embodiments includes a front panel 110 and a rear panel 120 which are coalesced with each other with a given distance therebetween. The front panel 110 includes a front substrate 111, on which a first electrode 112 and a second electrode 113 are formed. The rear panel 120 includes a rear substrate 121, on which a third electrode 123 is formed to intersect the first electrode 112 and the second electrode 113. The front substrate 111 includes a plurality of substrate depression portions spaced with a predetermined distance therebetween, and a plurality of electrode depression portions spaced with a predetermined distance therebetween. The substrate depression portions and the electrode depression portions will be described later.

The first electrode, the second electrode, and the third electrode are referred to as a scan electrode, a sustain electrode, and an address electrode, respectively.

The scan electrode 112 and the sustain electrode 113 are formed in parallel to each other on the front substrate 111 to generate a discharge inside discharge cells and to maintain the discharges of the discharge cells.

Electrical conductivity of the scan electrode 112 and the sustain electrode 113 needs to be considered to emit light generated within the discharge cell to the outside and to secure driving efficiency. Accordingly, the scan electrode 112 and the sustain electrode 113 may be formed of a metal with good electrical conductivity, for example, Ag. Driving signals are supplied to the scan electrode 112 and the sustain electrode 113.

An upper dielectric layer 114 for covering the scan electrode 112 and the sustain electrode 113 is formed on an upper portion of the front substrate 111 on which the scan electrode 112 and the sustain electrode 113 are positioned. The upper dielectric layer 114 limits discharge currents of the scan electrode 112 and the sustain electrode 113, and provides insulation between the scan electrode 112 and the sustain electrode 113. Since the front substrate 111 includes the substrate depression portions, the upper dielectric layer 114 may have a differential thickness.

A protective layer 115 is formed on an upper surface of the upper dielectric layer 114 to facilitate discharge conditions. The protective layer 115 may be formed of a material with a high secondary electron emission coefficient, for example, magnesium oxide (MgO).

The address electrode 123 is used to supply a data signal to the discharge cells.

A lower dielectric layer 125 for covering the address electrode 123 is formed on an upper portion of the rear substrate 121 on which the address electrode 123 is positioned. Although FIG. 1 has illustrated a case where the upper dielectric layer 114 and the lower dielectric layer 125 each are formed in the form of a single layer, at least one of the upper dielectric layer 114 and the lower dielectric layer 125 may be formed in the form of a plurality of layers.

A plurality of barrier ribs 122 for partitioning the discharge cells are positioned on an upper portion of the lower dielectric layer 125.

A phosphor layer 124 for emitting visible light for an image display during an address discharge is positioned inside the discharge cells partitioned by the barrier ribs 122. For instance, red (R), green (G) and blue (B) phosphor layers may be formed.

Driving signals are supplied to the scan electrode 112, the sustain electrode 113, and the address electrode 123 to generate a discharge inside the discharge cells, and thus the plasma display panel displays an image.

FIG. 1 has illustrated and described one example of the plasma display panel, and thus the present invention is not limited to the plasma display panel of FIG. 1. For instance, a black layer (not shown) for absorbing external light may be further formed on the upper portion of the barrier rib 122 to prevent the reflection of the external light caused by the barrier rib 122.

Further, a gap between the barrier ribs 122 may vary depending on color (for example, red (R), green (G), and blue (B)) of the phosphor layers.

Description will given below based on the structure of the plasma display panel illustrated in FIG. 1.

FIG. 2 illustrates a structure of a front panel of a plasma display panel according to a first embodiment.

Referring to FIG. 2, the front panel of the plasma display panel according to the first embodiment includes a front substrate 211, a plurality of scan electrodes 212 and a plurality of sustain electrodes 213, and an upper dielectric layer 214. The front substrate 211 includes a plurality of substrate depression portions 217a and 217b spaced from each other with a predetermined distance therebetween. The scan electrodes 212 and the sustain electrodes 213 are positioned between the substrate depression portions 217a and 217b. The upper dielectric layer 214 covers an upper portion of the front substrate 211 on which the scan electrodes 212 and the sustain electrodes 213 are positioned, the scan electrodes 212, and the sustain electrodes 213.

The scan electrode 212 and the sustain electrode 213 are formed in parallel to each other on the front substrate 211 to generate a discharge inside discharge cells and to maintain the discharges of the discharge cells.

A black layer 216 for preventing the reflection of external light is formed between the scan electrode 212 and the sustain electrode 213 closest to the scan electrode 212. The black layer 216 reflects visible light generated by the discharge to maximize the quantity of visible light emitted into the scan electrode 212 and the sustain electrode 213 and to maximize the reflection of the external light, thus preventing glare of the screen caused by the reflection of the external light. Accordingly, the black layer 216 improves bright room contrast.

The substrate depression portions 217a and 217b are portions formed by depressing the front substrate 211 by a predetermined depth h1 and a predetermined width W1. The depth h1 of the substrate depression portions 217a and 217b is equal to or less than one half of a whole thickness gh of the front substrate 211. The width W1 of the substrate depression portions 217a and 217b may range from 100 μm to 900 μm.

The reason why the depth h1 of the substrate depression portions 217a and 217b is equal to or less than one half of the whole thickness gh of the front substrate 211 is to support the plurality of scan electrodes 212, the plurality of sustain electrodes 213, the upper dielectric layer 214, and a protective layer (not shown) formed on the front substrate 211 while standing against a pressure generated when coalescing a front panel including the front substrate 211 and the rear panel. The reason why the width W1 of the substrate depression portions 217a and 217b ranges from 100 μm to 900 μm is to consider the whole size of barrier ribs formed on the rear panel and the whole size of the discharge cells partitioned by the barrier ribs.

A width W2 of the scan electrode 212 and the sustain electrode 213 is less than one quarter of the width W1 of the substrate depression portions 217a and 217b. A formation direction of the width W2 is the same as a formation direction of the width W1. When the width W2 of the scan electrode 212 and the sustain electrode 213 is within the above range, the discharge is more smoothly generated and discharge efficiency improves.

The upper dielectric layer 214 covers the upper portion of the front substrate 211 on which the substrate depression portions 217a and 217b are formed, and upper portions of the scan electrode 212 and the sustain electrode 213. The upper dielectric layer 214 may have a substantially constant thickness. In other words, a thickness th1 of the upper dielectric layer 214 positioned on an upper portion of the substrate depression portions 217a and 217b may be substantially equal to a thickness th2 of the upper dielectric layer 214 positioned on the remaining potion excepting the substrate depression portions 217a and 217b from the front substrate 211. The thickness th1 of the upper dielectric layer 214 may range from 5 μM to 100 μm. Although the upper dielectric layer 214 has the substantially constant thickness, the shape of the upper dielectric layer 214 may be the same as the shape of the front substrate 211 by the substrate depression portions 217a and 217b.

When the shape of the upper dielectric layer 214 is the same as the shape of the front substrate 211, the discharge efficiency improves. When applying predetermined driving signals to the plurality of scan electrodes 213 and the plurality of sustain electrodes 213, wall charges are accumulated on the upper portion of the upper dielectric layer 214 such that a discharge occurs. The large amount of wall charges are accumulated on a depressed portion of the upper dielectric layer 214 formed by the substrate depression portions 217a and 217b. Accordingly, a discharge occurs at a low firing voltage by the large amount of wall charges accumulated on the depressed portion of the upper dielectric layer 214 such that the discharge efficiency improves.

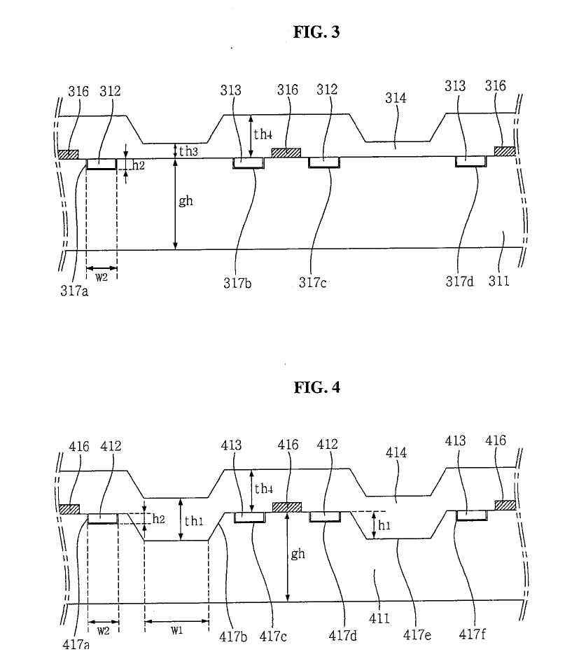

FIG. 3 illustrates a structure of a front panel of a plasma display panel according to a second embodiment.

Referring to FIG. 3, the front panel of the plasma display panel according to the second embodiment includes a front substrate 311, a plurality of scan electrodes 312 and a plurality of sustain electrodes 313, and an upper dielectric layer 314. The front substrate 311 includes a plurality of electrode depression portions 317a, 317b, 317c and 317d spaced from each other with a predetermined distance therebetween. The scan electrodes 312 and the sustain electrodes 313 are positioned inside the electrode depression portions 317a, 317b, 317c and 317d. The upper dielectric layer 314 is formed on an upper portion of the front substrate 311, and has a differential thickness.

A black layer 316 for preventing the reflection of external light is formed between the scan electrode 312 and the sustain electrode 313 closest to the scan electrode 312 on the upper portion of the front substrate 311. Since the black layer 316 was fully described in the first embodiment with reference to FIG. 2, a description thereof is omitted.

The electrode depression portions 317a, 317b, 317c and 317d are portions formed by depressing the front substrate 311 by a predetermined depth h2 and a predetermined width W2. The depth h2 of the electrode depression portions 317a, 317b, 317c and 317d is equal to or less than one half of a whole thickness gh of the front substrate 311. The width W2 of the electrode depression portions 317a, 317b, 317c and 317d is substantially equal to a width of the scan and sustain electrodes 312 and 313.

The reason why the depth h2 of the electrode depression portions 317a, 317b, 317c and 317d is equal to or less than one half of the whole thickness gh of the front substrate 311 is substantially the same as the reason described in FIG. 2, thus being omitted. When the width W2 of the electrode depression portions 317a, 317b, 317c and 317d is substantially equal to the width of the scan and sustain electrodes 312 and 313, it is easy to constantly set a gap between the scan and sustain electrodes 312 and 313 positioned inside the electrode depression portions 317a, 317b, 317c and 317d and a process speed of the scan and sustain electrodes 312 and 313 is further rapid. Accordingly, the size of the scan and sustain electrodes 312 and 313 may be substantially equal to the size of the electrode depression portions 317a, 317b, 317c and 317d.

The upper dielectric layer 314 covers the upper potion of the front substrate 311 and upper potions of the scan and sustain electrodes 312 and 313.

The upper dielectric layer 314 has a differential thickness. In other words, a thickness th4 of the upper dielectric layer 314 on the scan and sustain electrodes 312 and 313 and the black layer 316 positioned inside the electrode depression portions 317a, 317b, 317c and 317d may be more than a thickness th3 of the upper dielectric layer 314 on which the scan and sustain electrodes 312 and 313 and the black layer 316 are not positioned. The thickness th4 of the upper dielectric layer 314 may range from 5 μm to 100 μm.

As above, since the upper dielectric layer 314 has the differential thickness, a discharge space of a discharge cell, in which a discharge occurs, widens such that discharge efficiency improves. When applying predetermined driving signals to the plurality of scan electrodes 313 and the plurality of sustain electrodes 313, wall charges are accumulated on the upper portion of the upper dielectric layer 314 with the differential thickness such that a discharge occurs. The large amount of wall charges are accumulated on a depressed portion of the upper dielectric layer 314 formed by the substrate depression portions 317a and 317b. Accordingly, a discharge occurs at a low firing voltage by the large amount of wall charges accumulated on the depressed portion of the upper dielectric layer 314 by the thicknesses th3 and th4 such that the discharge efficiency improves.

FIG. 4 illustrates a structure of a front panel of a plasma display panel according to a third embodiment.

Referring to FIG. 4, the front panel of the plasma display panel according to the third embodiment includes a front substrate 411, a plurality of scan electrodes 412 and a plurality of sustain electrodes 413, and an upper dielectric layer 414 positioned on the front substrate 411. The front substrate 411 includes a plurality of electrode depression portions 417a, 417c, 417d and 417f spaced from each other with a predetermined distance therebetween, and a plurality of substrate depression portions 417b and 417e positioned between the electrode depression portions 417a, 417c, 417d and 417f. The scan electrodes 412 and the sustain electrodes 413 are positioned inside the electrode depression portions 417a, 417c, 417d and 417f.

A black layer 416 for preventing the reflection of external light is formed between the scan electrode 412 and the sustain electrode 413 closest to the scan electrode 412 on the upper portion of the front substrate 411. Since the black layer 416 was fully described in the first embodiment with reference to FIG. 2, a description thereof is omitted.

The scan electrode 412 on the electrode depression portion 417a, the substrate depression portion 417b, the sustain electrode 413 on the electrode depression portion 417c, the black layer 416, the scan electrode 412 on the electrode depression portion 417d, the substrate depression portion 417e, and the sustain electrode 413 on the electrode depression portion 417f may be formed on the front substrate 411 in the order named.

The substrate depression portions 417b and 417e are portions formed by depressing the front substrate 411 by a predetermined depth h1 and a predetermined width W1. Further, the electrode depression portions 417a, 417c, 417d and 417f are portions formed by depressing the front substrate 411 by a predetermined depth h2 and a predetermined width W2. The depth h1 of the substrate depression portions 417b and 417e and the depth h2 of the electrode depression portions 417a, 417c, 417d and 417f each are equal to or less than one half of a whole thickness gh of the front substrate 411. The width W2 of the electrode depression portions 417a, 417c, 417d and 417f is substantially equal to a width of the scan and sustain electrodes 412 and 413. The width w1 of the substrate depression portions 417b and 417e may range from 100 μm to 900 μm.

The reason why the depth h1 of the substrate depression portions 417b and 417e and the depth h2 of the electrode depression portions 417a, 417c, 417d and 417f each are equal to or less than one half of the whole thickness gh of the front substrate 411 is to support the plurality of scan electrodes 412, the plurality of sustain electrodes 413, the upper dielectric layer 414, and a protective layer (not shown) formed on the front substrate 411 while standing against a pressure generated when coalescing a front panel including the front substrate 411 and the rear panel.

When the width W2 of the electrode depression portions 417a, 417c, 417d and 417f is substantially equal to the width of the scan and sustain electrodes 412 and 413, it is easy to constantly set a gap between the scan and sustain electrodes 412 and 413 positioned inside the electrode depression portions 417a, 417c, 417d and 417f and a process speed of the scan and sustain electrodes 412 and 413 is further rapid. Accordingly, the size of the scan and sustain electrodes 412 and 413 may be substantially equal to the size of the electrode depression portions 417a, 417c, 417d and 417f.

The width w2 of the electrode depression portions 417a, 417c, 417d and 417f is less than one quarter of the width W1 of the substrate depression portions 417b and 417e. A formation direction of the width W2 is the same as a formation direction of the width W1. When the width W1 of the substrate depression portions 417b and 417e is within the above range, the discharge is more smoothly generated and discharge efficiency improves.

The reason why the width W1 of the substrate depression portions 417b and 417e ranges from 100 μm to 900 μm is to consider the whole size of barrier ribs formed on the rear panel and the whole size of the discharge cells partitioned by the barrier ribs.

The depth h2 of the electrode depression portions 417a, 417c, 417d and 417f may be less than the depth h1 of the substrate depression portions 417b and 417e. The electrode depression portions 417a, 417c, 417d and 417f are the depressed portion on the front substrate 411 to position the scan and sustain electrodes 412 and 413 inside the electrode depression portions 417a, 417c, 417d and 417f. The substrate depression portions 417b and 417e are the depressed portion on the front substrate 411 to widen a discharge occurrence space.

The upper dielectric layer 414 covers the upper portion of the front substrate 411 including the electrode depression portions 417a, 417c, 417d and 417f inside which the scan electrodes 412 and the sustain electrodes 413 are positioned, and the substrate depression portions 417b and 417e. The upper dielectric layer 414 may have a substantially constant thickness. In other words, a thickness th1 of the upper dielectric layer 414 positioned on an upper portion of the substrate depression portions 417b and 417e may be substantially equal to a thickness th4 of the upper dielectric layer 414 positioned on the electrode depression portions 417a, 417c, 417d and 417f. The thicknesses th1 and th4 of the upper dielectric layer 214 may range from 5 μm to 100 μm.

Although the upper dielectric layer 414 has the substantially constant thickness, the shape of the upper dielectric layer 414 is the same as the shape of the front substrate 411 by the substrate depression portions 417b and 417e formed on the front substrate 411.

Since the effect caused by the structure of the front panel according to the third embodiment was described in the first and second embodiments, a description thereof is omitted.

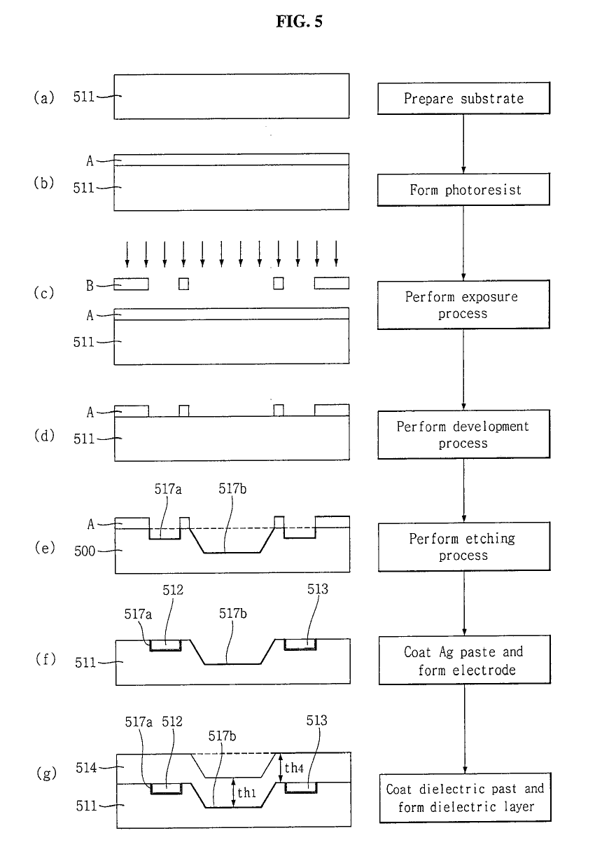

The following is a detailed description of processes for manufacturing the front panel according to the embodiments, with reference to FIG. 5.

FIG. 5 illustrates a method of manufacturing the front panel described in FIG. 4. In FIG. 5, the electrode depression portion and the substrate depression portion are referred to as a first pattern 517a and a second pattern 517b, respectively. The method of manufacturing the front panel according to the embodiments comprises forming a first pattern 517a with a predetermined depth and a second pattern 517b with a predetermined depth on a substrate 511, forming the electrodes in the first pattern 517a, and forming a dielectric layer 514 on the substrate 511 on which the first pattern 517a and the second pattern 517b are formed.

Referring to (a) of FIG. 5, the front substrate 511 is prepared. Referring to (b) of FIG. 5, a photoresist A is coated on the upper portion of the front substrate 511. Referring to (c) of FIG. 5, a photomask B with a predetermined pattern is put on the upper portion of the photoresist A and light is irradiated on the photomask B, thereby hardening the photoresist A. An exposure process is then performed on the front substrate 511. Referring to (d) of FIG. 5, a development process is performed on the front substrate 511 to clean the remaining photoresist A, which is not hardened, and to remove the photoresist A exposed to the light.

Referring to (e) of FIG. 5, an etching process is performed on a portion of the front substrate 511, on which the photoresist A is not formed, to form the plurality of first patterns 517a and the plurality of second patterns 517b each having the predetermined depth.

While the first and second patterns 517a and 517b are formed using the etching process, the first pattern 517a may be formed using laser beam machining. In other words, the first pattern 517a may be formed by irradiating a laser beam for the accuracy in arrangement of the electrodes.

Referring to (f) of FIG. 5, a metal paste is coated on the first pattern 517a using a screen printing method. The metal paste may use Ag with good conductivity. In other words, a predetermined screen mask is positioned on the front substrate 511. A squeezer functions as a brush and Ag paste functions as a paint such that the Ag paste is printed by a reciprocating motion of the squeezer. A green sheet of a film type for the electrodes is manufactured, and the electrodes are coated on the front substrate 511 using a laminating method. Accordingly, the scan electrodes 512 and the sustain electrodes 513 are formed on the plurality of first patterns 517a of the front substrate 511.

Referring to (g) of FIG. 5, a white dielectric paste is coated on the front substrate 511 using the screen printing method to cover the scan electrodes 512 and the sustain electrodes 513. The dielectric paste is differentially coated in a reference line corresponding to the second pattern 517b of the front substrate 511. A height th4 of the dielectric paste on the first pattern 517a is substantially equal to a height th1 of the dielectric paste on the second pattern 517b.

The dielectric paste may be coated using a laminating method. Accordingly, the upper dielectric layer 514 of a differential structure having the substantially constant thickness is formed on the front substrate 511. In other words, the height th4 of the dielectric layer 514 on the first pattern 517a is substantially equal to the height th1 of the dielectric layer 514 on the second pattern 517b.

A process for manufacturing an indium-tin-oxide (ITO) transparent electrode is not necessary to form the scan electrode 512 and the sustain electrode 513 in the first patterns 517a of the front substrate 511. Since the height th4 of the upper dielectric layer 514 on the first pattern 517a is substantially equal to the height th1 of the dielectric layer 514 on the second pattern 517b, the upper dielectric layer 514 is formed using one of the screen printing method or the laminating method. Therefore, an additional process for the upper dielectric layer 514 is not necessary.

Since the number of processes for manufacturing the front substrate 511 is reduced by the scan electrode 512 and the sustain electrode 514 each having only a bus electrode made of Ag and the upper dielectric layer 514, the manufacturing yield improves and the manufacturing cost is reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a substrate comprising a plurality of substrate depression portions spaced from each other with a predetermined distance therebetween;
a plurality of electrodes positioned between the substrate depression portions; and
a dielectric layer covering upper portions of the plurality of electrodes and an upper portion of the substrate.

2. The plasma display panel of claim 1, wherein a depth of the substrate depression portion is equal to or less than one half of a thickness of the substrate.

3. The plasma display panel of claim 1, wherein a width of the substrate depression portion ranges from 100 μm to 900 μm.

4. The plasma display panel of claim 3, wherein a width of the electrode is less than one quarter of the width of the substrate depression portion.

5. The plasma display panel of claim 1, wherein a thickness of the dielectric layer formed on an upper portion of the substrate depression portion is substantially equal to a thickness of the dielectric layer formed on the remaining portion excepting the substrate depression portion from the substrate.

6. The plasma display panel of claim 5, wherein a thickness of the dielectric layer ranges from 5 μm to 100 μm.

7. The plasma display panel of claim 1, further comprising a black layer positioned between a first electrode of the plurality of electrodes and a second electrode of the plurality of electrodes closest to the first electrode on the upper portion of the substrate.

8. A plasma display panel comprising:
a substrate comprising a plurality of electrode depression portions spaced from each other with a predetermined distance therebetween;
a plurality of electrodes positioned inside the electrode depression portions; and
a dielectric layer with a differential thickness positioned on an upper portion of the substrate.

9. The plasma display panel of claim 8, further comprising a black layer positioned between a first electrode of the plurality of electrodes and a second electrode of the plurality of electrodes closest to the first electrode on the upper portion of the substrate.

10. The plasma display panel of claim 9, wherein a thickness of the dielectric layer positioned on an area where the plurality of electrodes and the black layer are positioned is more than a thickness of the dielectric layer positioned on an area where the plurality of electrodes and the black layer are not positioned.

11. The plasma display panel of claim 10, wherein a thickness of the dielectric layer positioned on an area where the plurality of electrodes and the black layer are positioned ranges from 5 μm to 100 μm.

12. The plasma display panel of claim 8, wherein a depth of the electrode depression portion is equal to or less than one half of a thickness of the substrate.

13. A plasma display panel comprising:
a substrate comprising a plurality of electrode depression portions spaced from each other with a predetermined distance therebetween and a plurality of substrate depression portions positioned between the electrode depression portions;
a plurality of electrodes positioned inside the electrode depression portions; and
a dielectric layer positioned on an upper portion of the substrate.

14. The plasma display panel of claim 13, wherein a depth of the electrode depression portion and a depth of the substrate depression portion each are equal to or less than one half of a thickness of the substrate.

15. The plasma display panel of claim 14, wherein the depth of the electrode depression portion is less than the depth of the substrate depression portion.

16. The plasma display panel of claim 13, wherein a width of the substrate depression portion ranges from 100 μm to 900 μm.

17. The plasma display panel of claim 13, wherein a width of the substrate depression portion is more than a width of the electrode depression portion.

18. The plasma display panel of claim 13, wherein a thickness of the dielectric layer positioned on an upper portion of the electrode depression portion is substantially equal to a thickness of the dielectric layer positioned on an upper portion of the substrate depression portion.

19. The plasma display panel of claim 18, wherein the thickness of the dielectric layer ranges from 5 μm to 100 μm.

20. The plasma display panel of claim 13, further comprising a black layer positioned between a first electrode of the plurality of electrodes and a second electrode of the plurality of electrodes closest to the first electrode on the upper portion of the substrate.
